(19) United States
(12) Patent Application Publication
(10) Pub. No.: US 2005/0227821 A1
(43) Pub. Date: Oct. 13, 2005

(54) Aquatic exercise apparatus and method therefor

(76) Inventors: Richmond Powell, Boulder City, NV (US); Mark R. Beltz, Silverado, CA (US)

Correspondence Address: WEISS & MOY PC, 4204 NORTH BROWN AVENUE, SCOTTSDALE, AZ, 85251, US

(21) Appl. No.: 10/816,258

(22) Filed: Apr. 1, 2004

(51) Int. Cl. F16L 11/118; A63B 31/00

(52) U.S. Cl. 482/55

(57) ABSTRACT

An aquatic exercise apparatus and method therefor comprised of two flotation devices connected by a plurality of tube members that can be easily and inexpensively adjusted by length and angle, allowing a person to swim by cranking two flotation devices while kicking his or her feet. Preferably, PVC tubes and PVC elbows are used so that the overall length of the aquatic exercise device and the length between a first handle and a second handle can be easily and inexpensively adjusted by substituting PVC tubes of different lengths and PVC elbows of different angles. In this way, swimmers of different sizes can use the same aquatic exercise apparatus by adjusting it to their preference. Additionally, a single swimmer can adjust the aquatic swimming apparatus in order to focus on different muscle groups.

### FIELD OF THE INVENTION

This invention relates generally to aquatic exercise devices and methods therefor and, more specifically, to an apparatus having two flotation devices connected by a plurality of polyvinyl chloride tubes and polyvinyl chloride elbows enabling a user to adjust the apparatus as desired by length and angle.

### BACKGROUND OF THE INVENTION

Swimming is a popular form of exercise as well as a sport. Water allows for low-impact exercise, allowing people to build muscle strength in their arms, legs, and other body parts. Some people, however, have difficulty supporting their body in water for long periods of time. For this reason, some swimmers require a flotation assist device in order to allow them to exercise in the water. Kickboards and other lighter than water objects are often used to allow a swimmer to hold on with their hands while exercising their legs. In order to achieve a more complete workout, however, a device that can both float as well as provide a workout for one's upper body is preferred.

Several attempts have been made to address this need. For example, U.S. Pat. No. 4,832,631 issued to Gag, U.S. Pat. No. 3,580,213 issued to Yuen, U.S. Pat. No. 2,416,471 issued to Chappedelaine, and U.S. Pat. No. 1,349,891 issued to Kuznetzoff all show various types of swimming devices comprising two flotation devices connected to one another and having two handles for a person to paddle by rotating the handles while kicking the feet. None of the aforementioned prior art allow a person to adjust the dimensions of the swimming device to make it wider, narrower, or otherwise adjust the angles. Adjustment of this kind is necessary, however, when people of different sizes desire to use the same device. A person with broad shoulders for example, will need a wider aquatic exercise apparatus than a smaller person with narrower shoulders. Even if only one person is using the aquatic exercise device, adjustment is preferable to allow a person to concentrate on different muscle groups by adjusting the angles of the device.

One prior art swimming apparatus attempts to solve this problem. U.S. Pat. No. 1,777,749 issued to Eguiluz utilizes an adjustable sleeve connected to the two hand grips, allowing for the handles to be adjusted diagonally from one another. The Eguiluz design, although providing for some adjustment, only permits diagonal adjustment of the space between the handles. Without the ability to also adjust the length and angle of the other sections and elbows of the exercise device, a person is unable to increase the overall width of the device, or angle of usage, without simultaneously increasing the distance between the handle grips.

A need therefore existed for an aquatic exercise apparatus that preferably utilizes polyvinyl chloride (PVC) tubes and elbows, making it possible for a person to adjust the length of each individual section by replacing one tube of PVC with a PVC tube of a different length. Additionally, a need existed for an aquatic exercise apparatus that allows for elbows of various bend angles to be used in order to further adjust the aquatic exercise apparatus to a person's preferences.

### SUMMARY OF THE INVENTION

An object of the present invention is to provide an aquatic exercise apparatus capable of allowing a user to make various adjustments to the distance and angles between two flotation devices and between two handles, and a method therefor.

### BRIEF DESCRIPTION OF THE PREFERRED EMBODIMENTS

In accordance with one embodiment of the present invention, an aquatic exercise apparatus is disclosed, comprising, in combination, a first flotation device having a density less than water, a second flotation device having a density less than water, a first polyvinyl chloride tube having a first end and a second end, the first end being dimensioned to mate with the first flotation device, a second polyvinyl chloride tube having a first end and a second end, the first end of the second polyvinyl chloride tube dimensioned to mate with the second flotation device, a first polyvinyl chloride elbow having a first end and a second end, the second end of the first polyvinyl chloride tube dimensioned to securely mate with the first end of the first elbow, a second polyvinyl chloride elbow having a first end and a second end, the second end of the second polyvinyl chloride tube dimensioned to securely mate with the first end of the second elbow, a third polyvinyl chloride tube having a first end and a second end, the first end of the third polyvinyl chloride tube dimensioned to mate with the second end of the first polyvinyl chloride elbow, a fourth polyvinyl chloride tube having a first end and a second end, the first end of the fourth polyvinyl chloride tube dimensioned to mate with the second end of the second polyvinyl chloride elbow, a third polyvinyl chloride elbow having a first end and a second end, the second end of the third polyvinyl chloride tube dimensioned to securely mate with the first end of the third elbow, a fourth polyvinyl chloride elbow having a first end and a second end, the second end of the fourth polyvinyl chloride tube dimensioned to securely mate with the first end of the fourth elbow, a fifth polyvinyl chloride tube having a first end and a second end, the first end of the fifth polyvinyl chloride tube dimensioned to mate with the second end of the third polyvinyl chloride elbow, a sixth polyvinyl chloride tube having a first end and a second end, the first end of the sixth polyvinyl chloride tube dimensioned to mate with the second end of the fourth polyvinyl chloride elbow, a first polyvinyl chloride gripping tube having a first end and a second end and having a diameter greater than the fifth polyvinyl chloride tube and a length less than the fifth polyvinyl chloride tube, the fifth polyvinyl chloride tube dimensioned to be inserted through the first polyvinyl chloride gripping tube so that the first polyvinyl chloride gripping tube being dimensioned to rotate around and relative to the fifth polyvinyl chloride tube, a second polyvinyl chloride gripping tube having a first end and a second end and having a diameter greater than the sixth polyvinyl chloride tube and a length less than the sixth polyvinyl chloride tube, the sixth polyvinyl chloride tube dimensioned to be inserted through the second polyvinyl chloride gripping tube so that the second polyvinyl chloride gripping tube being dimensioned to rotate around and relative to the sixth polyvinyl chloride tube, a fifth polyvinyl chloride elbow having a first end and a second end, the second end of the fifth polyvinyl chloride tube dimensioned to securely mate with the first end of the fifth elbow, a sixth polyvinyl chloride elbow having a first end and a second end, the second end of the sixth polyvinyl chloride tube dimensioned to securely mate with the first end of the sixth elbow, and a seventh polyvinyl chloride tube having a first end and a second end, the first end of the seventh polyvinyl chloride tube dimensioned to mate with the second end of the fifth elbow, the second end of the seventh polyvinyl chloride tube dimensioned to mate with the second end of the sixth elbow.

In accordance with another embodiment of the present invention, an aquatic exercise apparatus is disclosed, comprising, in combination, a first flotation device having a density less than water, a second flotation device having a density less than water, a first polyvinyl chloride tube having a first end and a second end, the first end being dimensioned to mate with the first flotation device, a second polyvinyl chloride tube having a first end and a second end, the first end of the second polyvinyl chloride tube dimensioned to mate with the second flotation device, a first polyvinyl chloride elbow having a first end and a second end, the second end of the first polyvinyl chloride tube dimensioned to securely mate with the first end of the first elbow, a second polyvinyl chloride elbow having a first end and a second end, the second end of the second polyvinyl chloride tube dimensioned to securely mate with the first end of the second elbow, a third polyvinyl chloride tube having a first end and a second end, the first end of the third polyvinyl chloride tube dimensioned to mate with the second end of the first polyvinyl chloride elbow, a fourth polyvinyl chloride tube having a first end and a second end, the first end of the fourth polyvinyl chloride tube dimensioned to mate with the second end of the second polyvinyl chloride elbow, a first polyvinyl chloride gripping tube having a first end and a second end and having a diameter greater than the third polyvinyl chloride tube and a length less than the third polyvinyl chloride tube, the third polyvinyl chloride tube dimensioned to be inserted through the first polyvinyl chloride gripping tube so that the first polyvinyl chloride gripping tube being dimensioned to rotate around and relative to the third polyvinyl chloride tube, a second polyvinyl chloride gripping tube having a first end and a second end and having a diameter greater than the fourth polyvinyl chloride tube and a length less than the fourth polyvinyl chloride tube, the fourth polyvinyl chloride tube dimensioned to be inserted through the second polyvinyl chloride gripping tube so that the second polyvinyl chloride gripping tube being dimensioned to rotate around and relative to the fourth polyvinyl chloride tube, a third polyvinyl chloride elbow having a first end and a second end, the second end of the third polyvinyl chloride tube dimensioned to securely mate with the first end of the third elbow, a fourth polyvinyl chloride elbow having a first end and a second end, the second end of the fourth polyvinyl chloride tube dimensioned to securely mate with the first end of the fourth elbow, and a fifth polyvinyl chloride tube having a first end and a second end, the first end of the fifth polyvinyl chloride tube dimensioned to mate with the second end of the third elbow, the second end of the fifth polyvinyl chloride tube dimensioned to mate with the second end of the fourth elbow.

In accordance with yet another embodiment of the present invention, an aquatic exercise apparatus is disclosed, comprising, in combination, a first flotation device having a density less than water, a second flotation device having a density less than water, a first handle, a second handle, and a plurality of tube members dimensioned to be coupled to the first flotation device and the second flotation device and the first handle and the second handle so that the first handle and the second handle and the plurality of tube members being adjustable in length and disposed of between the first flotation device and the second flotation device.

In accordance with still another embodiment of the present invention, a method for aquatic exercise is disclosed, comprising, in combination, the steps of providing a first flotation device having a density less than water, providing a second flotation device having a density less than water, providing a first handle, providing a second handle, providing a plurality of tube members, coupling one of the plurality of tube members to the first flotation device, coupling another of the plurality of tube members to the second flotation device, coupling one of the plurality of tube members to the first handle, coupling one of the plurality of tube members to the second handle, all the plurality of tube members being disposed of between the first flotation device and the second flotation device, and adjusting a distance between at least one of the first handle and the second handle, and the first flotation device and the second flotation device.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of one embodiment of the aquatic exercise apparatus of the present invention.

FIG. 1A is a perspective view of another embodiment of the aquatic exercise apparatus of the present invention, showing longer tubes being coupled to the first flotation device and the second flotation device in order to increase the width of the aquatic exercise apparatus.

FIG. 1B is a perspective view of another embodiment of the aquatic exercise apparatus of the present invention, in which fewer tubes are used than in the aquatic exercise apparatus of FIG. 1 in order to decrease the width of the aquatic exercise apparatus.

FIG. 2 is a perspective view of another embodiment of the aquatic exercise apparatus of the present invention in which elbows having a less than 90 degree bend are used to increase the width of both the aquatic exercise device as well as the distance between the first handle and the second handle.

FIG. 3 is a perspective view of the aquatic exercise apparatus of FIG. 1, showing a swimmer (in phantom) gripping the first handle and the second handle.

FIG. 3A is a perspective view of another embodiment of the aquatic exercise apparatus of the present invention in which the first flotation device and the second flotation device are shaped like propellers.

FIG. 4 is a perspective view of a flotation device having the shape of a pyramid.

FIG. 4A is a perspective view of a flotation device having the shape of a propeller.

FIG. 4B is a perspective view of a flotation device having the shape of a cross.

FIG. 5 is a side, cross-sectional view of the gripping tube coupled around another tube having a smaller diameter.

FIG. 6 is a perspective view of the gripping tube coupled to another tube that is coupled to an elbow.

### DETAILED DESCRIPTION OF THE PREFERRED EMBODIMENTS

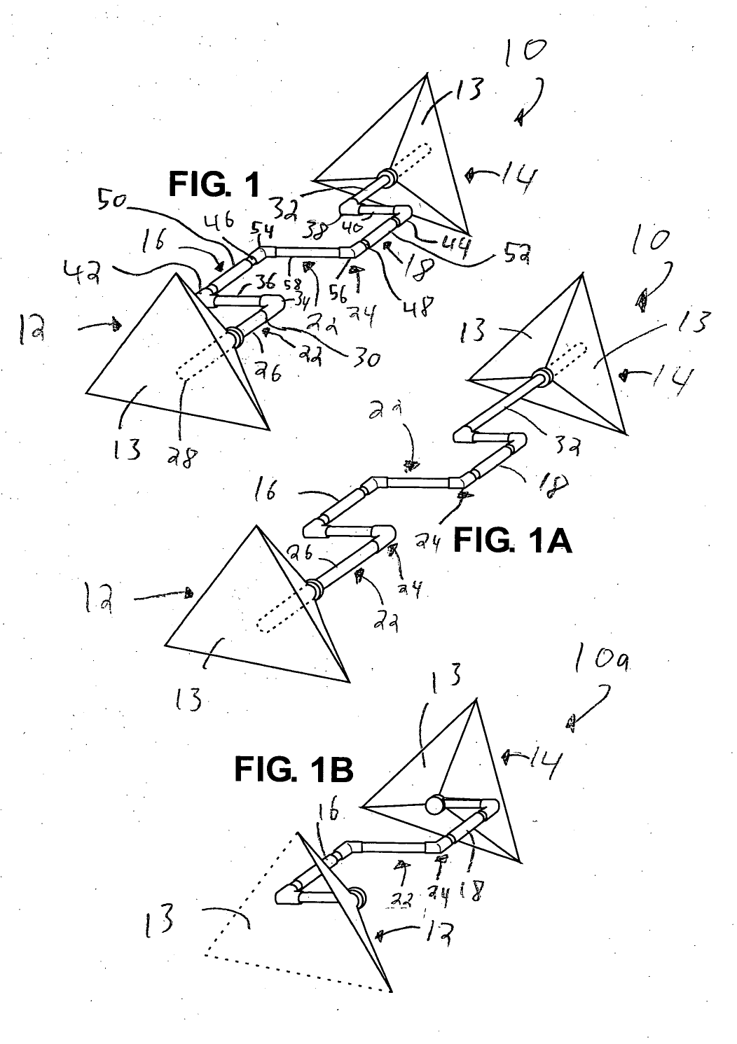

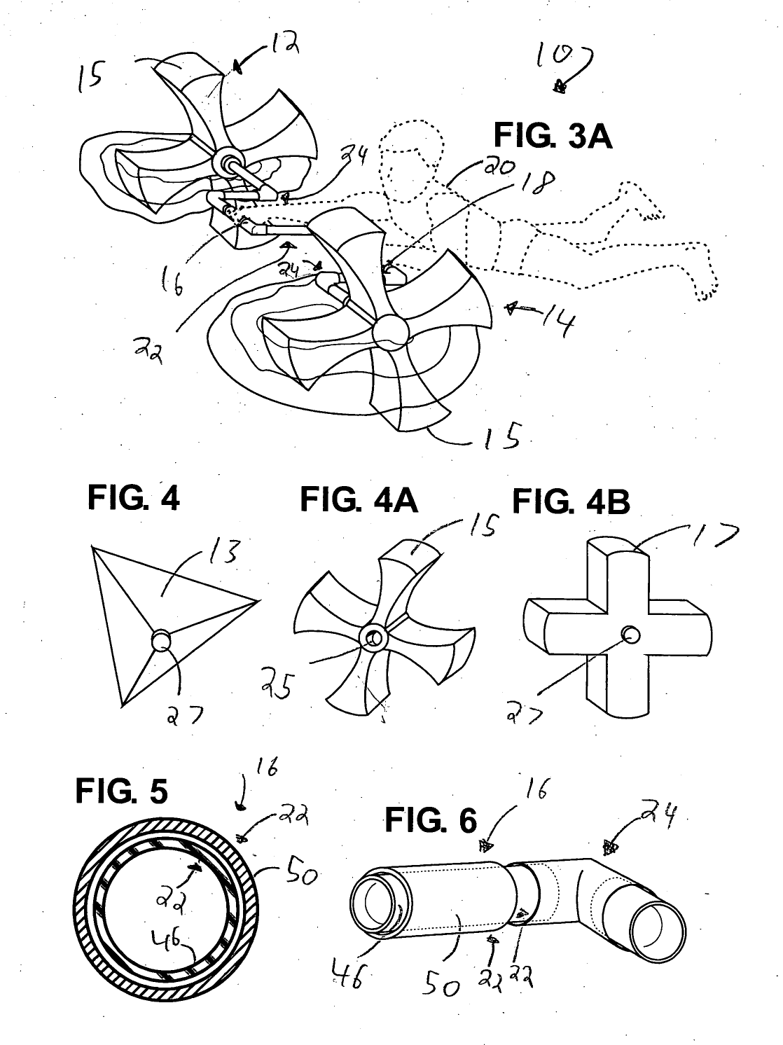

Referring to FIGS. 1, 1A, 2, 3 and 3A, reference number 10 refers generally to the aquatic exercise apparatus of the present invention. The aquatic exercise apparatus 10 generally comprises a first flotation device 12 and a second flotation device 14, each having a density less than water. The first flotation device 12 and the second flotation device 14 can be in the shape of a pyramid 13 (shown in FIGS. 1, 1A, 1B, 2, 3, and 4), a propeller 15 (shown in FIGS. 3A and 4A), a cross 17 (shown in FIG. 4B) or any other shape so long as the flotation device has a density less than water.

Referring now to FIGS. 1, 1A, 2, 3, and 3A, the aquatic exercise apparatus 10 further comprises a first handle 16 and a second handle 18. The first handle 16 and the second handle 18 are dimensioned to be grasped by a swimmer 20 (shown in FIGS. 3 and 3A). A plurality of tube members 22, preferably made of polyvinyl chloride (PVC) are used to couple the first flotation device 12 and the second flotation device 14 to the first handle 16 and the second handle 18 and to one another so that the first handle 16 and the second handle 18 and the tube members 22 are disposed of between the first flotation device 12 and the second flotation device 14. While, in the preferred embodiment, the aquatic exercise apparatus 10 comprises a plurality of PVC tube members 22, it should be clearly understood that substantial benefit could be derived from an alternative embodiment of the present invention in which an alternative material is used, so long as it is readily available in different lengths in order to permit a person to couple together tubes members 22 of different lengths in order to adjust the width of the aquatic exercise apparatus 10. Preferably, the aquatic exercise apparatus comprises a plurality of coupling elbows 24 dimensioned to couple the plurality of tube members 22 to the first handle 16 and the second handle 18 and to other tube members 22.

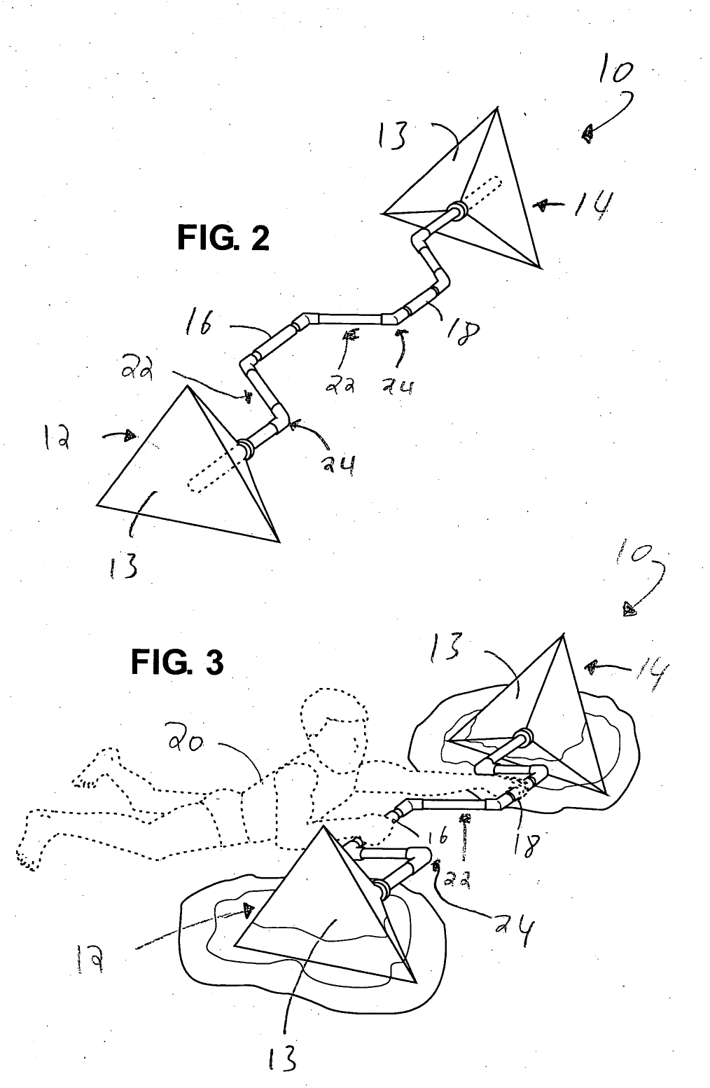

In one embodiment of the aquatic exercise apparatus 10, shown in FIG. 1, the aquatic exercise apparatus 10 comprises a first PVC tube 26 having a first end 28 dimensioned to mate with the first flotation device 12. Preferably, the first end 28 of the first PVC tube 26 is inserted into an aperture 25 (shown in FIG. 4A) defined by the first flotation device 12, although it should be clearly understood that substantial benefit could be derived from an alternative embodiment of the present invention, in which the first PVC tube 26 is coupled in some other way to the first flotation device 12, such as by coupling to a protruding peg 27 (shown in FIGS. 4 and 4B). In a similar fashion, a second PVC tube 32 is coupled to a second flotation device 14. Preferably, the second end 30 of the first PVC tube 26 is coupled to one end of a first PVC elbow 34. One end of a third PVC tube 36 is coupled to the other end of the first PVC elbow 34. Similarly, a second PVC elbow 38 is coupled to one end of a fourth PVC tube 40. The other end of the third PVC tube 36 is coupled to one end of a third PVC elbow 42. Similarly, the other end of the fourth PVC tube 40 is coupled to one end of a fourth PVC elbow 44. A fifth PVC tube 46 is coupled to the other end of the third PVC elbow 42. Similarly, a sixth PVC tube 48 is coupled to the other end of the fourth PVC elbow 44. The fifth PVC tube 46 is inserted into a first PVC gripping tube 50 having a diameter greater than the fifth PVC tube 46 so that the first PVC gripping tube 50 is dimensioned to rotate around and relative to the fifth PVC tube 46. The first PVC gripping tube 50 is preferably what forms the first handle 16. Similarly, the sixth PVC tube 48 is inserted into a second PVC gripping tube 52 having a diameter greater than the sixth PVC tube 48 so that the second PVC gripping tube 52 is dimensioned to rotate around and relative to the sixth PVC tube 48. The second PVC gripping tube 52 is preferably what forms the second handle 18. The other end of the fifth PVC tube 46 is coupled to one end of a fifth PVC elbow 54. Similarly, the other end of the sixth PVC tube 48 is couple to one end of a sixth PVC elbow 56. A first end of a seventh PVC tube 58 is coupled to the other end of the fifth PVC elbow 54 and a second end of the seventh PVC tube 58 is coupled to the other end of the sixth PVC elbow 56. By using these plurality of PVC tubes and PVC elbows, a person is able to easily assemble and disassemble the aquatic exercise apparatus 10, as well as adjust the distance both between the first handle 16 and the second handle 18 as well as the distance between the first flotation device 12 and the second flotation device 14 by using PVC tubes and elbows of varying lengths and angles. The availability and diversity of PVC allows one to easily assemble and modify the aquatic exercise apparatus 10. Using PVC elbows of less than 90 degrees for example, as shown in FIG. 2, allows a person to widen the distance between the first handle 16 and the second handle 18 without altering any of the lengths of any of the PVC tubes.

Referring now to FIG. 1B, an alternative embodiment of the aquatic exercise apparatus 10, hereinafter 10a, is shown. The aquatic exercise apparatus 10a is essentially the same as the aquatic exercise apparatus 10, except that two less PVC tubes 22 and two less PVC elbows 24 are used to couple the first flotation device 12 to the second flotation device 14. This is a simpler, smaller version, which illustrates the versatility that using PVC tubes and elbows provides when assembling and modifying the aquatic exercise apparatus 10.

Referring now to FIG. 1A, a relatively wider version of the aquatic exercise apparatus 10 is shown. The first PVC tube 26 and the second PVC tube 32 are relatively longer than other PVC tubes in order to increase the overall width of the aquatic exercise apparatus 10 by increasing the distance between the first flotation device 12 and the second flotation device 14.

Referring now to FIGS. 5 and 6, preferably the first handle 16 and the second handle 18 are constructed by using two PVC tubes 22, one being inserted to another having a greater diameter. The interior PVC tube 22 preferably has a smaller diameter and a greater length than the exterior PVC tube 22 (shown in FIG. 5 as the first PVC tube gripping member 50). In this way, the exterior tube 22 can be grasped by a person 20 and rotated about the interior tube 22 in order to allow a swimmer 20 to crank the aquatic exercise apparatus 10 in the water and initiate movement. While, in the preferred embodiment, the first handle 16 and the second handle 18 are comprised of an interior PVC tube 22 and an exterior PVC tube 22, it should be clearly understood that substantial benefit could be derived from an alternative configuration of the aquatic exercise apparatus 10 of the present invention in which the first handle 16 and the second handle 18 are comprised of another material, so long as the rest of the plurality of tube members are interchangeable in order to permit easy adjustment of the aquatic exercise apparatus 10.

### Statement of Operation

In order to make use of the aquatic exercise apparatus 10, a person preferably couples PVC tubes 22 to a first flotation device 12 and a second flotation device 14, using PVC elbows 24 to couple the sections together in order to create a crank that can be used to propel a swimmer 20 forward in water when the swimmer 20 cranks the aquatic exercise apparatus 10 while kicking his or her feet.

It should be clearly understood that it is within the spirit and scope of this invention that the tube members 22 may be fixedly coupled together (for example with glue) to create increased stability. Adjustment would then be accomplished by simply sawing off the PVC tube members 22 and replacing them. It is because of the availability of PVC and other plastics that may be used, that the aquatic exercise apparatus can be easily and inexpensively adjusted.

While the invention has been particularly shown and described with reference to preferred embodiments thereof, it will be understood by those skilled in the art that the foregoing and other changes in form and details may be made therein without departing from the spirit and scope of the invention.

1. An aquatic exercise apparatus comprising, in combination:
a first flotation device having a density less than water;
a second flotation device having a density less than water;
a first polyvinyl chloride tube having a first end and a second end, said first end being dimensioned to mate with said first flotation device;
a second polyvinyl chloride tube having a first end and a second end, said first end of said second polyvinyl chloride tube dimensioned to mate with said second flotation device;
a first polyvinyl chloride elbow having a first end and a second end, said second end of said first polyvinyl chloride tube dimensioned to securely mate with said first end of said first elbow;
a second polyvinyl chloride elbow having a first end and a second end, said second end of said second polyvinyl chloride tube dimensioned to securely mate with said first end of said second elbow;
a third polyvinyl chloride tube having a first end and a second end, said first end of said third polyvinyl chloride tube dimensioned to mate with said second end of said first polyvinyl chloride elbow;
a fourth polyvinyl chloride tube having a first end and a second end, said first end of said fourth polyvinyl chloride tube dimensioned to mate with said second end of said second polyvinyl chloride elbow;
a third polyvinyl chloride elbow having a first end and a second end, said second end of said third polyvinyl chloride tube dimensioned to securely mate with said first end of said third elbow;
a fourth polyvinyl chloride elbow having a first end and a second end, said second end of said fourth polyvinyl chloride tube dimensioned to securely mate with said first end of said fourth elbow;
a fifth polyvinyl chloride tube having a first end and a second end, said first end of said fifth polyvinyl chloride tube dimensioned to mate with said second end of said third polyvinyl chloride elbow;
a sixth polyvinyl chloride tube having a first end and a second end, said first end of said sixth polyvinyl chloride tube dimensioned to mate with said second end of said fourth polyvinyl chloride elbow;
a first polyvinyl chloride gripping tube having a first end and a second end and having a diameter greater than said fifth polyvinyl chloride tube and a length less than said fifth polyvinyl chloride tube, said fifth polyvinyl chloride tube dimensioned to be inserted through said first polyvinyl chloride gripping tube so that said first polyvinyl chloride gripping tube being dimensioned to rotate around and relative to said fifth polyvinyl chloride tube;
a second polyvinyl chloride gripping tube having a first end and a second end and having a diameter greater than said sixth polyvinyl chloride tube and a length less than said sixth polyvinyl chloride tube, said sixth polyvinyl chloride tube dimensioned to be inserted through said second polyvinyl chloride gripping tube so that said second polyvinyl chloride gripping tube being dimensioned to rotate around and relative to said sixth polyvinyl chloride tube;
a fifth polyvinyl chloride elbow having a first end and a second end, said second end of said fifth polyvinyl chloride tube dimensioned to securely mate with said first end of said fifth elbow;
a sixth polyvinyl chloride elbow having a first end and a second end, said second end of said sixth polyvinyl chloride tube dimensioned to securely mate with said first end of said sixth elbow; and
a seventh polyvinyl chloride tube having a first end and a second end, said first end of said seventh polyvinyl chloride tube dimensioned to mate with said second end of said fifth elbow, said second end of said seventh polyvinyl chloride tube dimensioned to mate with said second end of said sixth elbow.

2. The aquatic exercise device of claim 1 wherein said first flotation device defines a first aperture and said second flotation device defines a second aperture, said first end of said first polyvinyl chloride tube being dimensioned to be inserted into said first aperture and said first end of said second polyvinyl chloride tube being dimensioned to be inserted into said second aperture.

3. The aquatic exercise device of claim 1 wherein said first flotation device comprises a first substantially round peg and said second flotation device comprises a second substantially round peg, said first peg being dimensioned to be inserted into said first end of said first polyvinyl chloride tube and said second peg being dimensioned to be inserted into said first end of said second polyvinyl chloride tube.

4. The aquatic exercise device of claim 1 wherein each said first polyvinyl chloride tube, said second polyvinyl chloride tube, said third polyvinyl chloride tube, said fourth polyvinyl chloride tube, said fifth polyvinyl chloride tube and said sixth polyvinyl chloride tube being of a same length and diameter.

5. The aquatic exercise device of claim 1 wherein each said first polyvinyl chloride elbow, said second polyvinyl chloride elbow, said third polyvinyl chloride elbow, said fourth polyvinyl chloride elbow, said fifth polyvinyl chloride elbow and said sixth polyvinyl chloride elbow having an approximately 90 degree bend.

6. The aquatic exercise device of claim 1 wherein at least one of said first polyvinyl chloride elbow, said second polyvinyl chloride elbow, said third polyvinyl chloride elbow, said fourth polyvinyl chloride elbow, said fifth polyvinyl chloride elbow and said sixth polyvinyl chloride elbow having an approximately 45 degree bend.

7. The aquatic exercise device of claim 1 wherein at least one of said first polyvinyl chloride tube, said second polyvinyl chloride tube, said third polyvinyl chloride tube, said fourth polyvinyl chloride tube, said fifth polyvinyl chloride tube, said sixth polyvinyl chloride tube and said seventh polyvinyl chloride tube has a length being one of longer and shorter than a length of at least one other said first polyvinyl chloride tube, said second polyvinyl chloride tube, said third polyvinyl chloride tube, said fourth polyvinyl chloride tube, said fifth polyvinyl chloride tube, said sixth polyvinyl chloride tube and said seventh polyvinyl chloride tube.

8. The aquatic exercise device of claim 1 wherein said first flotation device and said second flotation device having a shape of at least one of a pyramid, a cross, and a propeller.

9. An aquatic exercise apparatus comprising, in combination:
a first flotation device having a density less than water;
a second flotation device having a density less than water;
a first polyvinyl chloride tube having a first end and a second end, said first end being dimensioned to mate with said first flotation device;
a second polyvinyl chloride tube having a first end and a second end, said first end of said second polyvinyl chloride tube dimensioned to mate with said second flotation device;
a first polyvinyl chloride elbow having a first end and a second end, said second end of said first polyvinyl chloride tube dimensioned to securely mate with said first end of said first elbow;
a second polyvinyl chloride elbow having a first end and a second end, said second end of said second polyvinyl chloride tube dimensioned to securely mate with said first end of said second elbow;
a third polyvinyl chloride tube having a first end and a second end, said first end of said third polyvinyl chloride tube dimensioned to mate with said second end of said first polyvinyl chloride elbow;
a fourth polyvinyl chloride tube having a first end and a second end, said first end of said fourth polyvinyl chloride tube dimensioned to mate with said second end of said second polyvinyl chloride elbow;
a first polyvinyl chloride gripping tube having a first end and a second end and having a diameter greater than said third polyvinyl chloride tube and a length less than said third polyvinyl chloride tube, said third polyvinyl chloride tube dimensioned to be inserted through said first polyvinyl chloride gripping tube so that said first polyvinyl chloride gripping tube being dimensioned to rotate around and relative to said third polyvinyl chloride tube;
a second polyvinyl chloride gripping tube having a first end and a second end and having a diameter greater than said fourth polyvinyl chloride tube and a length less than said fourth polyvinyl chloride tube, said fourth polyvinyl chloride tube dimensioned to be inserted through said second polyvinyl chloride gripping tube so that said second polyvinyl chloride gripping tube being dimensioned to rotate around and relative to said fourth polyvinyl chloride tube;
a third polyvinyl chloride elbow having a first end and a second end, said second end of said third polyvinyl chloride tube dimensioned to securely mate with said first end of said third elbow;
a fourth polyvinyl chloride elbow having a first end and a second end, said second end of said fourth polyvinyl chloride tube dimensioned to securely mate with said first end of said fourth elbow; and
a fifth polyvinyl chloride tube having a first end and a second end, said first end of said fifth polyvinyl chloride tube dimensioned to mate with said second end of said third elbow, said second end of said fifth polyvinyl chloride tube dimensioned to mate with said second end of said fourth elbow.

10. The aquatic exercise device of claim 9 wherein said first flotation device comprises a first sleeve having a diameter greater than said first polyvinyl chloride tube, said first end of said first polyvinyl chloride tube being dimensioned to be inserted into said first sleeve; and
wherein said second flotation device comprises a second sleeve having a diameter greater than said second polyvinyl chloride tube, said first end of said second polyvinyl chloride tube being dimensioned to be inserted into said second sleeve.

11. The aquatic exercise device of claim 9 wherein each said first polyvinyl chloride tube, said second polyvinyl chloride tube, said third polyvinyl chloride tube and said fourth polyvinyl chloride tube being of a same length and diameter.

12. The aquatic exercise device of claim 9 wherein each said first polyvinyl chloride elbow, said second polyvinyl chloride elbow, said third polyvinyl chloride elbow and said fourth polyvinyl chloride elbow having an approximately 90 degree bend.

13. The aquatic exercise device of claim 9 wherein at least one of said first polyvinyl chloride elbow, said second polyvinyl chloride elbow, said third polyvinyl chloride elbow and said fourth polyvinyl chloride elbow having an approximately 45 degree bend.

14. The aquatic exercise device of claim 9 wherein at least one of said first polyvinyl chloride tube, said second polyvinyl chloride tube, said third polyvinyl chloride tube, said fourth polyvinyl chloride tube and said fifth polyvinyl chloride tube has a length being one of longer and shorter than a length of at least one other said first polyvinyl chloride tube, said second polyvinyl chloride tube, said third polyvinyl chloride tube, said fourth polyvinyl chloride tube and said fifth polyvinyl chloride tube.

15. An aquatic exercise apparatus comprising, in combination:
a first flotation device having a density less than water;
a second flotation device having a density less than water;
a first handle;
a second handle; and
a plurality of tube members dimensioned to be coupled to said first flotation device and said second flotation device and said first handle and said second handle so that said first handle and said second handle and said plurality of tube members being adjustable in length and disposed of between said first flotation device and said second flotation device.

16. The aquatic exercise device of claim 15 further comprising a plurality of coupling elbows dimensioned to couple said plurality of tube members to said first handle and said second handle and to other said plurality of tube members.

17. The aquatic exercise device of claim 15 wherein said plurality of tube members being comprised of polyvinyl chloride.

18. A method for aquatic exercise comprising, in combination, the steps of:
providing a first flotation device having a density less than water;
providing a second flotation device having a density less than water;
providing a first handle;
providing a second handle;
providing a plurality of tube members;
coupling one of said plurality of tube members to said first flotation device;
coupling another of said plurality of tube members to said second flotation device;
coupling one of said plurality of tube members to said first handle;
coupling one of said plurality of tube members to said second handle, all said plurality of tube members being disposed of between said first flotation device and said second flotation device; and
adjusting a distance between at least one of said first handle and said second handle, and said first flotation device and said second flotation device.

19. The method of claim 18 further comprising the step of selecting said plurality of tube members from a plurality of polyvinyl chloride tubes of more than one length.

20. The method of claim 18 further comprising the step of selecting more than one elbow from a plurality of polyvinyl chloride elbows of more than one bend degree.
